(19) United States
(12) Patent Application Publication
(10) Pub. No.: US 2014/0278184 A1
(43) Pub. Date: Sep. 18, 2014

(54) Zero Deadband Processing for Velocity Transmitters

(71) Applicant: DWYER INSTRUMENTS, INC., Michigan City, IN (US)

(72) Inventors: Rodney Corder, Chesterton, IN (US); Andrew Mieczkowski, Schererville, IN (US)

(73) Assignee: DWYER INSTRUMENTS, INC., Michigan City, IN (US)

(21) Appl. No.: 13/832,803

(22) Filed: Mar. 15, 2013

(51) Int. Cl. G01L 27/00

(52) U.S. Cl. CPC G01L 27/002
USPC 702/98

(57) ABSTRACT

Systems, apparatuses and methods are disclosure for adjusting and/or modifying outputs of sensors based on deadband effects, where sensor adjustments may be based on a value, which may be a constant, such as an error value for the sensor, or a dynamic value. Differential pressure values measured from the output of sensors are compared to the value, and, in response to the comparison, the output of the sensor may be set substantially to zero if the measured differential pressure value is less than the value. Otherwise, the measured differential pressure values are passed through if they are is equal to or greater than the value. Additional techniques employing zero offsets, span adjustment and error scale adjustments are further disclosed.

### TECHNICAL FIELD

The present disclosure is directed to techniques for improving operation and calibration of sensors. More specifically, the disclosure is directed to techniques for improving operation and calibration of fluid pressure sensors/transmitters.

### BACKGROUND INFORMATION

Pressure and velocity sensors are known to measure pressure of gases or liquids, where pressure is expressed as the force required to stop a gas or fluid from expanding, and is usually stated in terms of force per unit area. A pressure sensor usually acts as a transducer by a signal as a function of the pressure imposed. Pressure sensors can be used to measure variables such as fluid/gas flow, speed, water level, and altitude. Pressure sensors may sometimes be referred to as pressure transducers, pressure transmitters, pressure senders, pressure indicators, piezometers, and manometers. One issue affecting most, if not all, pressure transducers is that they are susceptible to sensor drift over time. Pressure sensor drift may be thought of as a gradual degradation of the sensor and other components that can make readings offset from the original calibrated state. Based on their intended application, sensors are engineered from various materials. When exposed to certain conditions, the sensors will respond differently depending on the physical properties of the materials chosen. As sensors will typically undergo some expansion and contraction when subject to pressure and temperature cycles, pressure change frequency and amplitude, temperature extremes, material responses and environmental changes, these effects will become factors contributing to drift. The magnitude of sensor drift will vary with actual usage and the conditions it is exposed to.

In addition, sensors are often susceptible to a deadband effect, which may be defined as a region of pressure where a change in pressure produces no change in measurement output or control signal. Many types of pressure sensing devices have a region slightly above and below zero pressure where the output does not vary. For example, a pressure sensing diaphragm is considered to be at rest when pressure is equal on both sides of a diaphragm, which is the case when venting a gauge reference or differential pressure measurement instrument. If the pressure is increased or decreased, the measurement output will not respond until the mechanical slackness of the diaphragm assembly has been removed by the increasing pressure difference. The threshold of positive and negative pressure around zero where no change in output is detected may be thought of as the deadband.

Another example of a pressure deadband is how the hysteresis of a pressure switch is used to create a process control deadband. A basic mechanical pressure switch may open and closes at different pressure points. In this example, a pressure switch may be set to close when the pressure is increased to 3 bar pressure, and reopens when pressure is reduced to 2.7 bar. The pressure difference of 0.3 bar between the opening and closing of the switch may be thought of as the deadband which is caused by the inherent pressure hysteresis of the switch technology. The deadband produced by a pressure sensor is important to its operation, since it provides a way of stabilizing control of a process without the need for additional dampening filters. Electronic pressure switches that utilize pressure sensing technology having smaller hysteresis will require electronic circuitry to adjust the open/close deadband.

There are a variety of equipment used to measure flow using differential pressure. Among them are Pitot tubes, Piezometer Rings, Orifice plates, Venturi Tubes, Elbows and Dall Tubes. These all share a common characteristic in that the flowing fluid (air, gas, steam, liquids, etc.) cause a pressure drop when encountering the equipment. In common practice, the pressure drop, ΔP is commonly referenced as a positive pressure drop in the measurement of the flow. Many of these devices will also indicate flow in the reverse direction, providing a pressure increase −ΔP which is commonly referenced as a negative pressure drop in the measurement of the flow. The pressure drop provided by this equipment is not necessarily symmetric across flow in the intended direction and flow in the reverse direction, but many times it is important to identify flow in the reverse direction.

Moreover, when determining velocity using a differential pressure transmitter, the velocity (and volumetric flow) is a function of the square root of the differential pressure drop, or

V=k\sqrt{ΔP} (1)
where
   V=velocity or volumetric flow,
   k=proportional constant, and
   ΔP=differential pressure.
      k, the proportional constant, may be based on the measurement equipment sensitivity to flow and the units that ΔP is measured in. The square root function, especially around zero, is very sensitive to minor variations in the pressure reading. As such, small errors in the pressure measurement near zero differential pressure introduces larger errors in the square root function used for the calculation. Manufactured transmitters typically have some inherent offset at zero. While this offset is typically maintained within the accuracy tolerances of the transmitter, the offset will typically be present nonetheless. Accordingly, depending on the sensor technology and pressure ranges involved, this offset may change or drift over time, which in turn may cause the zero offset to drift outside ranges of acceptable accuracy tolerances.

### BRIEF SUMMARY

Accordingly, various embodiments are disclosure for modifying outputs of sensors, based on an error value for the sensor, where a differential pressure value measured from the output of the sensor is used to compare the measured differential pressure value to the error value, and, in response to the comparison, setting the output of the sensor substantially to zero if the measured differential pressure value is less than the error value, and passing the measured differential pressure value if the measured differential pressure value is equal to or greater than the error value.

In other embodiments, techniques are disclosed for processing an output of a sensor in a circuit arrangement. Differential pressure values may be received from the sensor, and a deadband value may be established in a deadband function as a first deadband input. The differential pressure value may also be received in the deadband function as a second deadband input, where a deadband output is provided from the deadband function based on the deadband value and differential pressure value, wherein the deadband output is used in the circuit arrangement to set the differential pressure value substantially to zero if the deadband output is a first value (e.g., zero). Additionally the deadband output may be used in the circuit arrangement to pass the received differential pressure value if the deadband output is a second value (e.g., “1”). The deadband value may be arranged as a constant (e.g., sensor error value, minimum airflow value), or as a dynamic value that may be based on such values as a system setpoint, an actual operating velocity and time-based drift value. These and other/additional embodiments will be apparent to those skilled in the art after viewing the drawings and detailed description, which is found below.

### BRIEF DESCRIPTION OF THE DRAWINGS

The present invention is illustrated by way of example and not limitation in the figures of the accompanying drawings, in which like references indicate similar elements and in which:

FIG. 1 is an exemplary graph illustrating various velocity error bands;

FIG. 2 is an exemplary graph illustrating adjusted error bands for sensors via zero deadband under one embodiment;

FIG. 3 illustrates an exemplary effect of an output function on a sensor output under one embodiment;

FIG. 4A is an exemplary flow diagram for a pressure sensor velocity calculation under one embodiment;

FIG. 4B is an exemplary flow diagram of a flow transmitter applying zero deadband under one embodiment;

FIG. 5 is an exemplary flow diagram for a calibration/linearization function for a pressure sensor under one embodiment; and

FIG. 6 is an exemplary flow diagram for a zero following function for zero offset under one embodiment.

### DETAILED DESCRIPTION

Pressure and velocity transmitter applications often have differences between “no-flow” and minimum flow differential pressures. One such application that will be discussed in the present disclosure is an air-handler. The blower(s) will typically not be operated at less than around 10% of the rated flow due to inefficiencies. For these types of systems, flow readings at less than 10% are considered “zero-flow” for the purposes of the control system. As such, small offsets in the differential pressure can lead to fairly large phantom velocities being measured. As one example, error analysis may be performed on a differential pressure transmitter to illustrate at least some of the effects of small offsets on a zero reading. In this example, determining a velocity of Actual Cubic Feet Per Minute (ACFPM) for a differential pressure transmitter at a standard operating condition may be determined from (1) disclosed above as

ACFM=4247.7×\sqrt{ΔP}

For this exemplary volumetric flow calculation, conversion constant k value of 4247.77 was arbitrarily chosen from a Twin City 270 BC SWSI free inlet fan, which is air measuring device based on the principle of a flow nozzle, where the inlet cone of the fan is used as a flow nozzle. By measuring the pressure drop through the inlet cone, a flow can be calculated. The exemplary system comprises a piezometer ring mounted in the throat and a static pressure tap mounted on the face of the inlet cone. A differential pressure transducer and a digital display can be provided, where display is preferably capable of performing the square root function in order to read out in CFM directly. A pressure drop may be measured from the tap located on the face of the funnel to the piezometer ring in the throat. The inlet tap may be connected to a high-pressure side of the transducer and the piezometer ring is connected to a low-pressure side. Using pressure transmitters (e.g., 10 in WC transmitter) volumetric flow may be used to measure ACFM. As is shown in Table 1 below, the absolute differential pressure readings at zero for various (10 in WC) model inaccuracies (with reference to certain Dwyer instrument models) at differential pressure are less than optimal:

TABLE 1
Exemplary Transmitters and Errors at Zero

| | Inaccuracy | Pressure Error | | ACFM Error | ACFM Error |
|---|---|---|---|---|---|
| Model | (% FS) | (inWC) | \sqrt{Pressure Error} | (at 0 inWC) | % FS |
| 616-3 | 0.25% | 0.025 inWC | 0.158 | 672 ACFM | 5.00% |
| 616C-3 | 1.0% | 0.1 inWC | 0.316 | 1343 ACFM | 10.0% |
| 616KD-04 | 2.0% | 0.2 inWC | 0.447 | 1900 ACFM | 14.1% |

As can be appreciated by those skilled in the art, the percentage of full-scale inaccuracy (% FS) at zero ranges from 0.25% to 2.0%, which may result in ACFM error to be as high as 14.1%. However, when transmitters are operated at full scale (span), the error profile changes significantly, as is shown in Table 2:

TABLE 2
Exemplary Transmitters and Errors at Span

| | Inaccuracy | ACFM | ACFM | ACFM Error | ACFM Error |
|---|---|---|---|---|---|
| Model | (% FS) | (at 10 inWC) | (at (1-% FS)*10 inWC) | (at 10 inWC) | % FS |
| 616-3 | 0.25% | 13,432 ACFM | 13,404 ACFM | 29 ACFM | 0.21% |
| 616C-3 | 1.0% | 13,432 ACFM | 13,353 ACFM | 79 ACFM | 0.59% |
| 616KD-04 | 2.0% | 13,432 ACFM | 13,285 ACFM | 147 ACFM | 1.09% |

Thus, when used above half-span, even fairly inaccurate pressure transmitters may provide fairly accurate flow measurements. Nevertheless, the inaccuracies near zero differential pressure remain and need to be dealt with.

Turning to FIG. 1, the exemplary graph illustrates velocity error bands (± in % of Full Scale) of the various model inaccuracies discussed above in connection with Table 1. As can be seen for the different bands for ±0.25% (101-102), +1.0% (103-104), and ±2.0% (105-106), the lower error bound near 0 (zero) flow is asymmetric to the upper error bound because the square root of any negative number in such applications is typically interpreted as zero. Accordingly, for flow measurements, anything between 0 (zero) and the inaccuracy pressure (inaccuracy % FS*Span) can be treated as zero without affecting the overall accuracy of the velocity or volumetric flow output.

Turning to FIG. 2, a graph is illustrated showing error bands for the various transmitters discussed above with zero deadband that are adjusted according to an exemplary embodiment, where negative error values may be subjected to a square-root function (described in greater detail below) and zeroed out by maintaining a sensor output at 0 (zero) differential pressure until a measured pressure exceeds a transmitter error. In the graph of FIG. 2, in the different bands for ±0.25% (201-202), ±1.0% (203-204), and ±2.0% (205-206), it can be seen that the inaccuracies or errors for the positive bands (201, 203, 205) are substantially reduced. The function for various inaccuracies in each transmitter may be expressed as

$$ACFM = \{ \begin{matrix}Δ {P}_{MEAS} < inaccuracyFS = 0 \\ Δ {P}_{MEAS} \geq inaccuracyFS = k \times \sqrt{Δ {P}_{MEAS}}\end{matrix}$$

where
inaccuracyFS=inaccuracy % FS*Span
ΔP_{MEAS}=measured differential pressure drop
   This function has the effect of minimizing peak positive flow error at the low end by maintaining the output at 0 ΔP until the measured pressure drop exceeds the transmitter error. The effect of this is that there is no false positive flow in the zero deadband, and the maximum error overall does not exceed that of the sensor inaccuracy itself.

FIG. 3 illustrates the effect of an output function on the interpretation of the transmitter output in one embodiment, where the pressure scale shows the first 2.5 in WC to highlight the effects of the zero deadband at the lower end. Compared to the actual flow (301), no flow is reported for +2% (302) and −2% (303) until the measure pressure exceeds the pressure sensor inaccuracy. Above that point, flow is reported as accurately as the pressure sensor allows. Since the transmitter output is zeroed out in the deadband portion affecting the transmitter, the deadband effects may be effectively minimized or even eliminated.

In an alternate embodiment, fan flow may be used to determine the zero deadband. Here, the minimum fan flow is examined and utilized to determine zero deadband. For example, if the minimum fan flow determined by the control system is 10% of the maximum flow, and exemplary zero deadband function would be

\sqrt{ΔP_{MEAS}}=10%×\sqrt{ΔP_{SPAN}}

ΔP_{MEAS}=(10%)²×P_{SPAN}
and

$$ACFM = \{ \begin{matrix}Δ {P}_{MEAS} < {( 10 \% )}^{2} \times Δ {P}_{SPAN} = 0 \\ Δ {P}_{MEAS} \geq {( 10 \% )}^{2} \times Δ {P}_{SPAN} = k \times \sqrt{Δ {P}_{MEAS}}\end{matrix}$$

where
   ΔP_{MEAS}=measured differential pressure
ΔP_{SPAN}=maximum (span) differential pressure
   This configuration provides a constant zero deadband independent of the inaccuracy of the transmitter.

When dealing with only a single transmitter, the control system using zero deadband techniques described herein may be easily implemented in software embodied on a tangible medium in an apparatus or system. However, when dealing with fan arrays, where the aggregate measurement of multiple fans is the control set point, the effects of the zero offset due to inaccuracies in a transmitter can lead to further errors. As an example, a fan array with 6 fans can easily have an error that is 6 times that of a single transmitter. Table 3 provided below illustrates some combined inaccuracies of the various transmitters:

TABLE 3
Combined Errors of Transmitters In 6-Fan Array

| | | Single | 6 Fan Array | 6 Fan Array |
|---|---|---|---|---|
| | | Transmitter | Transmitter | Transmitter |
| | Inaccuracy | ACFM Error | ACFM Error | with Zero |
| Model | (% FS) | (at 0 inWC) | (at 0 inWC) | Deadband |
| 616-3 | 0.25% | 672 ACFM | 4,032 ACFM | 0 ACFM |
| 616C-3 | 1.0% | 1,343 ACFM | 8,058 ACFM | 0 ACFM |
| 616KD-04 | 2.0% | 1,900 ACFM | 11,400 ACFM | 0 ACFM |

Without utilizing zero deadband techniques described herein, combining multiple transmitters may lead to situations where, for example, when all 6 fans are off, the transmitters are nonetheless indicating that significant airflow exists in the system. This can cause material issues with a control system attempting to drive the output of the transmitter to zero, or reporting significant airflow to a Building Automation System control, even though there is no flow in the fan.

Turning to FIG. 4A, an exemplary flow diagram for a pressure transmitter-based velocity calculation is illustrated under one embodiment. It should be stressed that the embodiments of FIGS. 4A and 4B are merely some of the possible embodiments contemplated in this disclosure; clearly, other arithmetic substitutions, combinations or recombination may be applied by those skilled in the art. The exemplary process of FIG. 4A begins by receiving raw sensor readings from pressure sensor 401 and processing them through calibration/linearization function 402, which processes raw sensor signals to provide an accurate output of pressure sensor 401 in the required units (e.g., in WC, Pa, etc.). The processed sensor signals are then received in square root function 403, where the signals are multiplied (410) with conversion constant “k” 404 to provide a velocity or volumetric flow in the desired units (e.g., ACFM, M³/H, etc.).

FIG. 4B illustrates an exemplary flow diagram of a flow transmitter applying zero deadband techniques. Similar to FIG. 4A, raw sensor readings from pressure sensor 401 are received and processed through calibration/linearization function 402 (discussed in greater detail below), which processes raw sensor signals to provide an accurate output of pressure sensor 401 in the required units (e.g., in WC, Pa, etc.). Here, a deadband function 407 is provided, which may accept a calibrated differential pressure as one input, and a deadband 406 as another input to provide a 0-1 limited output. The output of deadband function 407 is multiplied 411 by the calibrated differential pressure from 402 to produce a differential pressure having a zero deadband to the square root function 403. It should be noted that deadband 406 may be a constant defined by a value such as the inaccuracy of the sensor, or the minimum airflow for the control system. Alternately, the deadband 406 may be dynamic, where deadband 406 is defined as a function of a desired system set point, actual system operating velocity, or a time-based function to provide for varying drift over time of the pressure sensor. In yet another alternative embodiment, the system may include a hysteresis where the deadband for ΔP rising from 0 is higher than the deadband for ΔP falling from a pressure higher than the rising deadband. Such a configuration would be advantageous for allowing a control system to operate at a lower ΔP once the system updates from the actual operation.

By defining “zero” via a deadband parameter, this concept may be extended to account for a zero drifting or wandering during a life cycle of a transmitter. As mentioned above, pressure transmitters naturally change over time, where this change is referred to as “stability” or “drift” and is typically specified by % FS/year. In many cases, the annual drift may exceed the initial inaccuracy of the transmitter. This would likely cause operational problems at a certain point in the future.

Turning to FIG. 5, an exemplary block diagram is provided to illustrate an algorithmic flow for a simplified calibration/linearization function for a pressure sensor. Again, it should be understood that the embodiments of FIG. 5 (as well FIG. 6) are merely some of the possible embodiments contemplated in this disclosure; clearly, other arithmetic substitutions, combinations or recombination may be applied by those skilled in the art. Here, pressure sensor is arithmetically coupled (503, 505) to zero offset 502 and slope/span adjustment 504 to provide adjusted output pressure 506. Generally speaking the algorithmic process of FIG. 5 is based on linear equation

y=mx+b

which, applied to the sensor signals in FIG. 5 yields

Pᵤₙᵢₜₛ=Slope×(P_{MEAS}+ZeroOffset)

where
ZeroOffset=b/m and
Slope=m.
   One advantage of this arrangement is that the ZeroOffset can be easily determined and controlled independently of slope.

As shown in FIG. 5, zero offset 502 is subtracted from the output of pressure sensor 501 in order to provide a numerical “0” for the pressure calculation. In this example, the non-linearity of pressure sensor 501 is assumed to be within the tolerance of the transmitter, and only a simple scaling of the function is required to bring the pressure measurement into the proper units. Of course, more complex linearization functions may be applied, e.g., where a slope (span) adjustment 504 is a function of the pressure sensor output in order to bring the final output non-linearity into the required specification.

Because it can be known when ΔP is within the deadband area, and ΔP may be assumed to be zero in the deadband area, this can be used advantageously to maintain a true “zero” for the transmitter. While the output is likely to be zero, as determined when ΔP is within the deadband area, the output of the ZeroOffset+PressureSensor may be used to determine an error for the actual zero. By subtracting a scaled error from the Zero Offset, one can eventually drive ZeroOffset to a true zero of the pressure sensor, and subsequently track changes over time.

FIG. 6 illustrates another embodiment demonstrating an algorithmic flow for a simplified zero following function for zero offset discussed above in connection with FIG. 5. Here, the output of the deadband function 615 (defined by deadband 614) is subtracted from “1” (611) to provide a signal indicating the output of pressure sensor 601 should be zero. Deadband function 615 may be identical to the ones in FIGS. 4A-B, or may alternately be an additional deadband function specifically configured for zero-following and having a narrower deadband or increased hysteresis. Under another alternative embodiment, instead of using a deadband function, a fan enable signal may be provided from a controller, so that when fan motor(s) are disabled, the zero-following would be enabled. However, an advantage of using the deadband function is that an additional signal from the Fan Array Controller is not necessary.

The modified deadband function may advantageously be used to either enable or disable feedback from the offset pressure sensor output. When enabled, the offset pressure sensor output is used as an error signal in the feedback loop (602, 502, 607-610). The error signal may be scaled by the error scale adjustment 608 and added to the zero offset 606 in the form of a correction. The corrected zero offset may then be subtracted from the pressure sensor output, thus continuing the feedback. As a practical matter, long-term drift of pressure sensor 601 may be assumed to be 1-2% per year (or 0.003%-0.005% per day). To account for this, error scale adjustment may preferably be selected at a very small value such that, over the long term, zero offset 606 will be forced to follow any drift in the pressure sensor zero. An exact error scale adjustment may be determined by how many seconds per day the deadband function is active, and how much drift is being accommodated. Over the long term, any disruptions caused during an increase in pressure from zero to above the deadband, or decrease in pressure falling below the Deadband to Zero, should be averaged out by the significantly longer portion of time the pressure is actually at zero.

Additionally, weather effects, such as wind, may cause actual flow to occur, causing a rise in the pressure sensor output. Error scale adjustment in such a case would need to be small enough so that sustained weather effects do not significantly change the zero offset. This use of the zero following permits a type of auto zero function where the zero of the pressure transmitter function is near the actual current zero of a pressure sensor.

While at least one example embodiment has been presented in the foregoing detailed description, it should be appreciated that a vast number of variations exist. The algorithms disclosed above may be executed by any processor-based apparatus or system known in the art, or may alternately be performed by analog electrical circuit equivalents. It should also be appreciated that the example embodiment or embodiments described herein are not intended to limit the scope, applicability, or configuration of the invention in any way. Rather, the foregoing detailed description will provide those skilled in the art with a convenient and edifying road map for implementing the described embodiment or embodiments. It should be understood that various changes can be made in the function and arrangement of elements without departing from the scope of the invention and the legal equivalents thereof.

What is claimed is:

1. A method of processing an output of a sensor in a circuit arrangement, comprising the steps of:
receiving a differential pressure value from the sensor;
receiving a deadband value in a deadband function as a first deadband input;
receiving the differential pressure value in the deadband function as a second deadband input;
providing a deadband output from the deadband function based on the deadband value and differential pressure value, wherein the deadband output is used in the circuit arrangement to set the differential pressure value substantially to zero if the deadband output is a first value.

2. The method of processing an output of a sensor as claimed in claim 1, wherein the deadband output is used in the circuit arrangement to pass the received differential pressure value if the deadband output is a second value.

3. The method of processing an output of a sensor as claimed in claim 2, wherein the first value is “0” and the second value is “1”.

4. The method of processing an output of a sensor as claimed in claim 2, wherein the deadband value is a constant.

5. The method of processing an output of a sensor as claimed in claim 4, wherein the constant comprises one of a sensor error value and a minimum airflow value.

6. The method of processing an output of a sensor as claimed in claim 2, wherein the deadband value is a dynamic value comprising one of a system setpoint, actual operating velocity and time-based drift value.

7. The method of processing an output of a sensor as claimed in claim 1, further comprising the step of subtracting a zero offset value from the differential pressure value received from the sensor prior to the differential pressure value being received in the deadband function.

8. The method of processing an output of a sensor as claimed in claim 7, further comprising the steps of subtracting the deadband output from a third value to provide a modified deadband output value, wherein the modified deadband output value is used in the circuit arrangement to enable or disable feedback from the a differential pressure value received from the sensor.

9. The method of processing an output of a sensor as claimed in claim 8, wherein the feedback is based on a summation of the zero offset value and a product of (i) the differential pressure value, (ii) the modified deadband output value and (iii) an error scale adjustment.

10. The method of processing an output of a sensor as claimed in claim 9, wherein the error scale adjustment is based on (i) a time period in which the deadband function is active, and (ii) a level of drift occurring in the sensor.

11. A method for processing an output of a sensor in a circuit arrangement, comprising the steps of:
receiving an error value for the sensor;
determining a differential pressure value measured from the output of the sensor;
comparing the measured differential pressure value to the error value, and, in response to the comparison,
setting the output of the sensor substantially to zero in the circuit arrangement if the measured differential pressure value is less than the error value; and
passing the measured differential pressure value in the circuit arrangement if the measured differential pressure value is equal to or greater than the error value.

12. The method of claim 11, wherein a velocity is determined from the passed differential pressure value, said velocity being determined according to k\sqrt{ΔP}, where k is a proportional constant, and ΔP is the differential pressure.

13. The method of claim 11, wherein the error value comprises one of a sensor error value, and a minimum airflow value.

14. The method of claim 11, wherein the error value is determined by a deadband function.

15. The method of claim 14, wherein the deadband function is a constant comprising one of a sensor error value, and a minimum airflow value.

16. The method of claim 14, wherein the deadband function is a dynamic value comprising one of a system setpoint, actual operating velocity and time-based drift value of the sensor.

17. The method of claim 14, further comprising the steps of processing an output from the deadband function to enable or disable feedback for the differential pressure value in the circuit arrangement.

18. The method of claim 17, further comprising the steps of subtracting the deadband function output from a constant value to provide a modified deadband output value, wherein the modified deadband output value is used in the circuit arrangement to enable or disable feedback from the a differential pressure value received from the sensor.

19. The method of claim 18, wherein the feedback is based on a summation of a zero offset value and a product of (i) the differential pressure value, (ii) the modified deadband output value and (iii) an error scale adjustment.

20. The method of claim 19, wherein the error scale adjustment is based on (i) a time period in which the deadband function is active, and (ii) a level of drift occurring in the sensor.
